(19) United States
(12) Patent Application Publication
(10) Pub. No.: US 2025/0362516 A1
(43) Pub. Date: Nov. 27, 2025

(54) GLASSES ARM DESIGN

(71) Applicant: Apple Inc., Cupertino, CA (US)

(72) Inventor: Depeng Wang, San Jose, CA (US)

(21) Appl. No.: 18/866,995

(22) PCT Filed: Jun. 13, 2023
(86) PCT No.: PCT/US2023/068387

§ 371 Date: Nov. 18, 2024

Related U.S. Application Data
(60) Provisional application No. 63/366,530, filed on Jun. 16, 2022.

(51) Int. Cl. G02B 27/01; G02C 5/14; G02C 11/00

(52) U.S. Cl. CPC G02B 27/0176; G02C 5/14; G02C 11/10; G02B 2027/0178

(57) ABSTRACT

An arm of a head-mountable display can include an arm tip, an arm hinge, and an enclosure. The enclosure can include a first surface, and a second surface opposing the first surface, where the enclosure defines an internal volume spanning between the arm tip and the arm hinge. The arm of the head-mountable display can further include a printed circuit board (PCB) positioned inside the internal volume, a heat source attached to the PCB, and a thermal path inside the internal volume. In certain instances, the thermal path inside the internal volume is directed from the heat source, through the first surface and the arm hinge, and towards an ambient environment.

### CROSS-REFERENCE TO RELATED APPLICATION(S)

This application is a National Stage filing based off of PCT Application No. PCT/US2023/068387, filed 13 Jun. 2023, and entitled “GLASSES ARM DESIGN” which claims priority to U.S. Provisional Patent Application No. 63/366,530, filed 16 Jun. 2022, and entitled “GLASSES ARM DESIGN,” the entire disclosure of which is hereby incorporated by reference.

### FIELD

The described embodiments relate generally to eyewear arms. More particularly, the present embodiments relate to managing thermal energy for electronic eyewear.

### BACKGROUND

Thermal ergonomics are a challenge for eyewear electronics (e.g., head-mountable electronics). In particular, thermal ergonomics are an increasing challenge as eyewear electronics are designed with reduced form factors which typically draw thermal elements closer to the user, which can add to user discomfort. Therefore, there is a need for improvement to reduce an amount of heat transferred to users. Additionally, there is a need for improvement to reduce component (e.g., battery) degradation from increased internal temperatures.

### SUMMARY

An aspect of the present disclosure relates to an arm of a head-mountable display that includes an arm tip, an arm hinge, and an enclosure. The enclosure can include a first surface, and a second surface opposing the first surface, where the enclosure defines an internal volume spanning between the arm tip and the arm hinge. The arm of the head-mountable display can further include a printed circuit board (PCB) positioned inside the internal volume, a heat source attached to the PCB, and a thermal path inside the internal volume. In certain instances, the thermal path inside the internal volume is directed from the heat source, through the first surface and the arm hinge, and towards an ambient environment.

In some examples, the arm of the head-mountable display includes a chassis connecting the PCB to the arm hinge, where the thermal path is directed from the heat source, through the PCB, through the chassis, through the arm hinge, and towards the ambient environment. Additionally or alternatively, the arm of the head-mountable display includes a thermal interfacing material and a thermal spreader material positioned over the heat source and the PCB. According to some examples, the thermal path can be directed from the heat source, through the thermal interfacing material, through the thermal spreader material, through the first surface, and towards the ambient environment.

In one or more examples, the first surface and the heat source define an air gap within the internal volume. In this example, the thermal path can be directed from the heat source, through the air gap, through the first surface, and towards the ambient environment. Additionally, in some examples, the heat source is positioned closer to the first surface than the second surface. Further, in certain examples, the heat source is oriented towards the first surface.

The arm of the head-mountable display can include a variety of different components. For example, the arm of the head-mountable display can include a battery positioned between the PCB and the second surface, where the PCB, the battery, and the second surface are spatially separated by respective air gaps.

Another aspect of the present disclosure relates to a head-mountable device. In some examples, a head-mountable device can include a display, an arm housing connected to the display, and an arm subassembly disposed in the arm housing. In particular examples, the arm housing includes a heat dissipation surface oriented towards an ambient environment. Further, in some examples, the arm subassembly can include a chassis, a PCB affixed to the chassis, and a system on chip (SoC) mounted onto the PCB and oriented towards the heat dissipation surface.

In one or more examples, the arm housing includes a seamless uni-body enclosure defining an internal volume between an arm tip and an arm hinge, where the arm hinge connects the arm subassembly to the display. Further, in some examples, the arm housing includes an assembly access into the internal volume, where the assembly access can be positioned proximate to the arm hinge.

In certain examples, a portion of the heat dissipation surface inside the arm housing includes a thermal lining that abuts the arm subassembly. In certain instances, the thermal lining draws heat away from the arm subassembly and towards the heat dissipation surface.

In one or more examples, the arm subassembly further includes thermal insulation disposed between the PCB and a surface of the arm housing opposite the heat dissipation surface. Additionally or alternatively, the arm subassembly further includes a thermal interfacing material and an epoxy molding compound.

Yet another aspect of the present disclosure relates to a thermal flow apparatus of an augmented reality (AR) glasses arm. In some examples, the thermal flow apparatus of the AR glasses arm includes a PCB, a heat source attached to the PCB, and at least one of a thermal interfacing material or a thermal spreader material positioned over the heat source and the PCB.

In one or more examples, the thermal flow apparatus of the AR glasses arm includes a heat dissipation surface oriented towards an ambient environment, the thermal spreader material lining an inner portion of the heat dissipation surface, and the thermal interfacing material positioned between the thermal spreader material and the heat source. Additionally or alternatively, the thermal flow apparatus of the AR glasses arm can include an arm hinge and a chassis thermally coupling the PCB, the thermal interfacing material, the thermal spreader material, and the arm hinge. In certain examples, a first portion of epoxy molding compound is positioned between the thermal interfacing material and the heat source and the PCB. Further, in certain examples, a second portion of epoxy molding compound is positioned between the PCB and a surface opposite the heat dissipation surface. In one or more examples, an insulator is positioned between the second portion of epoxy molding compound and the surface.

In one or more examples of the thermal flow apparatus, at least one of the thermal interfacing material or the thermal spreader material directs thermal energy away from the heat source and towards an ambient environment via at least one of natural conduction or non-force convection. In particular examples, the thermal flow apparatus further includes a heat dissipation surface, where the thermal spreader material includes at least one of a pitch-based carbon fiber material, a graphite material, or a copper material that lines the heat dissipation surface. In some examples, the heat dissipation surface spans between an arm tip and an arm hinge, where the thermal spreader material spreads a thermal load from the heat source across the heat dissipation surface. In certain examples, the thermal flow apparatus further includes a thermal path directed away from the heat source, across fibers of the pitch-based carbon fiber material, and to the heat dissipation surface towards an ambient environment.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1-2 illustrate a top view of an example of a head-mountable display worn on a head of a user.

FIG. 3 illustrates a cross-sectional top view of an example arm of a head-mountable display.

FIG. 4 illustrates a cross-sectional top view of an example arm of a head-mountable display.

FIG. 5 illustrates a cross-sectional top view of an example arm of a head-mountable display.

FIG. 6 illustrates a cross-sectional top view of an example arm of a head-mountable display.

FIG. 7 illustrates experimental results of implementing a thermal path during a test operation.

### DETAILED DESCRIPTION

The following descriptions are not intended to limit the examples to one preferred embodiment. To the contrary, it is intended to cover alternatives, modifications, and equivalents as can be included within the spirit and scope of the described examples as defined by the appended claims. Reference will now be made in detail to representative examples illustrated in the accompanying drawings.

The following disclosure relates to a head-mountable display. Examples of head-mountable displays can include virtual reality or augmented reality devices that include an optical component. In the case of augmented reality devices, optical eyeglasses can be worn on the head of a user such that optical lenses and/or optical displays are positioned in front of the user's eyes. In another example, a virtual reality device can be worn on the head of a user such that a display screen is positioned in front of the user's eyes.

In particular examples, a head-mountable display includes a display to present visualizations, an arm housing (or enclosure) connected to the display, and an arm subassembly inserted inside the arm housing. The arm housing can interface with a user to secure a display in position (e.g., in front of a user's eyes). In one example, the arm housing extends from an arm tip to an arm hinge. The arm tip can be positioned behind a user's ear. The arm hinge can connect to a display hinge for rotatably connecting the arm housing to the display.

The arm subassembly can include a variety of different components for operation of a head-mountable display. Example components of an arm subassembly include a microphone, speaker, battery, printed circuit board (PCB), system on chip, etc.

Other examples components of an arm subassembly include a chassis and hinge connection. As will be discussed below, an arm subassembly can include additional or alternative components (e.g., thermal-related components).

Operation of the head-mountable display creates heat. For example, a system on chip architecture inside the arm housing can generate heat as the system on chip (SoC) performs operations to generate visualizations via the display. The disclosed devices and apparatuses direct this heat in a predetermined fashion.

For example, the head-mountable display of the present disclosure directs heat away from a user, lending to an improved user experience in at least some cases. Indeed, conventional arm designs of electronic eyewear suffer from undesired heat transfer to the skin of a user wearing the electronic eyewear (e.g., around the temple or ear region of a user). This undesired heat transfer can be particularly acute during computationally intensive operations or longer operating durations of the conventional electronic eyewear. By contrast, the head-mountable display of the present disclosure can improve a user experience by predictably directing thermal energy away from a user and towards an ambient environment.

As another example of heat direction, the head-mountable display can be designed to direct heat away from device components. To illustrate, the head-mountable display can direct heat away from a battery inside the arm housing. In more detail, battery life in a system can decrease over time due to exposure to increased temperature levels. Accordingly, the head-mountable display can prolong battery life of the head-mountable display by reducing heat exposure to the battery. In this manner, the head-mountable display can improve a longevity for the battery and other temperature sensitive components.

The head-mountable display can direct heat in myriad different ways. In some examples, the head-mountable display includes one or more of a chassis, hinge, air gap, insulating material, thermal interfacing material, thermal spreader material, heat sink, etc. to direct heat in a predetermined fashion. It will be appreciated that the head-mountable display can utilize a variety of different combinations, configurations, and arrangements of such components (or designs) to provide a desired thermal ergonomic. In particular examples, the head-mountable display includes a particular combination of the foregoing to provide a specific thermal path (e.g., away from a user or a device component). As an example, the head-mountable display includes a thermal path that proceeds from a heat source mounted to a PCB, through a world-facing surface of the arm housing, and towards an ambient environment.

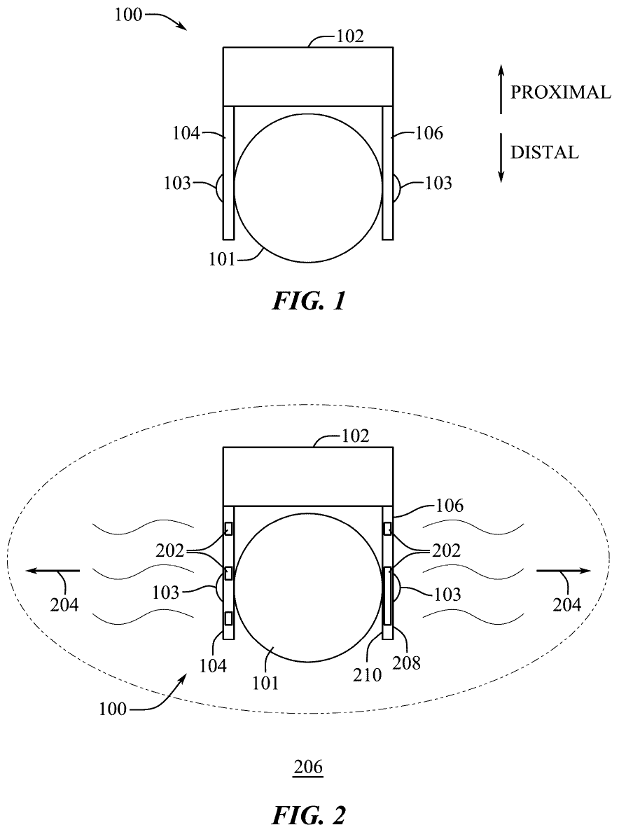

These and other examples are discussed below with reference to FIGS. 1-7. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1-2 illustrate a top view of an example of a head-mountable display 100 worn on a head 101 of a user. The head-mountable display 100 can include a display 102 (e.g., one or more optical lenses or display screens in front of the eyes of the user). The display 102 can include a display for presenting an augmented reality visualization, a virtual reality visualization, or other suitable visualization.

The head-mountable display 100 can also include one or more arms 104, 106 or straps. The arms 104, 106 are connected to the display 102 and extend distally toward the rear of the head 101. The arms 104, 106 are configured to secure the display 102 in a position relative to the head 101 (e.g., such that the display 102 is maintained in front of a user's eyes). For example, the securement arms 104, 106 extend over the user's ears 103. In certain examples, the arms 104, 106 rest on the user's ears 103 to secure the head-mountable display 100 via friction between the arms 104, 106 and the head 101. Additionally or alternatively, the arms 104, 106 can rest against the head 101. For example, the arms 104, 106 can apply opposing pressures to the sides of the head 101 to secure the head-mountable display 100 to the head 101. Additionally, the arms 104, 106 can attach to a back strap or other securement feature that secures the head-mountable display to the circumference or to a large portion of the head 101.

The terms “proximal” and “distal” can be used to reference the position of various components of devices described herein relative to the display 102 of the head-mountable display 100. The orientation of the “proximal” and “distal” directions relative to devices described herein is shown in FIG. 1.

As shown in FIG. 2, the head-mountable display 100 includes arm components 202 disposed inside the arms 104, 106. The arm components 202 can include a variety of different components. In particular examples, the arm components 202 include the electronic components for operating the head-mountable display 100. To illustrate, the arm components 202 include a microphone, speaker, battery, printed circuit board (PCB), system on chip, etc. It will be appreciated that such components can generate visualizations for presentation via the display 102. The arm components 202 can also include structural components, such as a chassis or hinge connection. Further, and as will be discussed below, the arm components 202 can include thermal-related components to direct heat. Additional details of the head dissipation are provided with reference to FIG. 2.

As shown in FIG. 2, the head-mountable display 100 generates heat 204. Generation of the heat 204, or thermal energy, can occur as part of normal operation of the head-mountable display 100. For example, the head-mountable display 100 generates the heat 204 in response to the arm components 202 processing computer-executable instructions to generate visualizations presented via the arm components 202.

Notwithstanding such heat generation, the head-mountable display 100 can dissipate the heat 204 towards an ambient environment 206. The ambient environment 206 refers to an area surrounding a user (e.g., the head 101). In one example, this directional heat dissipation away from the head 101 can lend to an improved user experience. For example, the head-mountable display 100 can dissipate the heat 204 via an outward-facing surface 208 of the arms 104, 106 that is oriented towards the ambient environment 206. In doing so, the head-mountable display 100 can reduce the amount of heat that dissipates through an inward-facing surface 210 of the arms 104, 106 oriented towards the head 101. This reduced heat dissipation through the inward-facing surface 210 is particularly useful because the inward-facing surface 210 can be in intimate contact with or in close proximity to the head 101. Therefore, the head-mountable display 100 can reduce an exposure of uncomfortable temperature levels to the head 101.

Although not expressly illustrated in FIG. 2, the head-mountable display 100 can also dissipate the heat 204 in a direction relative to certain components of the arm components 202. Indeed, as will be discussed below in relation to subsequent figures, the head-mountable display 100 can dissipate the heat in a direction (or along a thermal path) that reduces heat exposure to temperature sensitive components, such as a battery.

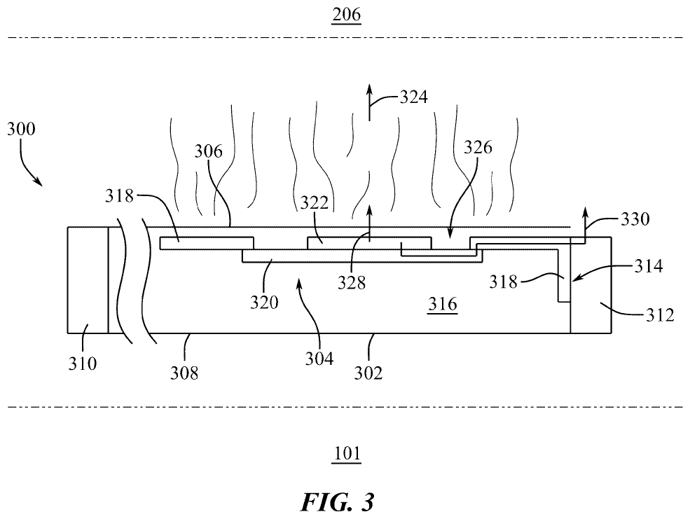

Any of the features, components, and/or parts, including the arrangements and configurations thereof shown in FIGS. 1-2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 1-2. Further details of a structural configuration of an arm that directs thermal energy away from sensitive components and/or the user are provided below with reference to FIG. 3.

FIG. 3 illustrates a cross-sectional top view of an example arm 300 of a head-mountable display. The arm 300 can be the same as or similar to the arms 104, 106 discussed above in relation to FIGS. 1-2.

As shown, the arm 300 includes an enclosure 302. As used herein, the terms “enclosure” or “housing” refer to a body portion of the arm 300. In some examples, the enclosure 302 defines the outer shell or surface profile of the arm 300. In particular, the enclosure 302 can include a first surface 306 oriented towards the ambient environment 206, and a second surface 308 oriented towards the head 101 of a user. The first surface 306 and the second surface 308 can extend at least partially between an arm tip 310 and an arm hinge 312. In certain instances, the first surface 306 and the second surface 308 span an entire distance between the arm tip 310 and the arm hinge 312.

As used herein, the term “arm tip” refers to an end region of the arm 300, as defined by the enclosure 302. The arm tip 310 can be positioned behind a user's ear. Additionally or alternatively, the arm tip 310 can press against the head 101 of a user for securing a head-mountable display. The arm tip 310 is positioned opposite of another end region of the arm 300 that abuts or connects to the arm hinge 312.

Additionally, as used herein, the term “arm hinge” refers to a hinge joint between the arm 300 and the display 102 (shown in FIGS. 1-2). Further detail with respect to the arm hinge 312 will be discussed below.

In some examples, the enclosure 302 includes a uni-body enclosure. For example, the first surface 306 and the second surface 308 form an integral whole or combination. To illustrate one example, the first surface 306 and the second surface 308 can combine together, mate, or join such that the enclosure 302 forms a singular shell. As another example, the first surface 306 and the second surface 308 reference discrete portions, sides, or regions of an otherwise indiscrete whole body of the arm 300. It will be appreciated that forming the enclosure 302 can be accomplished in myriad different ways (e.g., casting, injection molding, three-dimensional printing, machining, etc.).

In addition, the enclosure 302 can include a variety of different materials. In some examples, the enclosure 302 includes a metal material. For example, the enclosure 302 can include one or more base metals, such as titanium, stainless steel, tungsten, cobalt, aluminum, copper, lead, nickel, tin, zinc, gold, silver, etc. Additionally or alternatively, in certain examples, the enclosure 302 can include materials other than metal. For example, the enclosure 302 can include a polymer material, a carbon fiber material, a glass material, etc. Combinations of the foregoing are also herein contemplated. For instance, the enclosure 302 can be composed of one or more base materials, in addition to one or more coatings.

Further shown in FIG. 3, the enclosure 302 can define an assembly access 314 into an internal volume 316 within the arm 300. The assembly access 314 can be positioned in myriad different locations along the arm 300. For instance, as illustrated, the assembly access 314 is positioned proximate to the arm hinge 312. As an alternative example, the assembly access 314 can be positioned at the arm tip 310. In yet another example, the assembly access 314 can be positioned between arm tip 310 and the arm hinge 312. In certain examples, the assembly access 314 can be sized and shaped to allow insertion of an arm subassembly 304 into the internal volume 316.

As used herein, the term “arm subassembly” refers to components inside the arm 300. In particular examples, the arm subassembly 304 can include components assembled together as a unit for inserting into the enclosure 302. In some examples, the arm subassembly 304 includes a chassis 318, a printed circuit board (PCB) 320, and a system on chip (SoC) 322. Each is discussed in turn.

The term “chassis” refers to the one or more members that are connected to the arm hinge 312. In particular examples, the chassis 318 is configured to bear a load from one or more components mounted thereto. In certain examples, the chassis 318 transfers or distributes this load to the arm hinge 312. Additionally, as will be discussed below, the chassis 318 can include thermal conductivity properties for heat transfer.

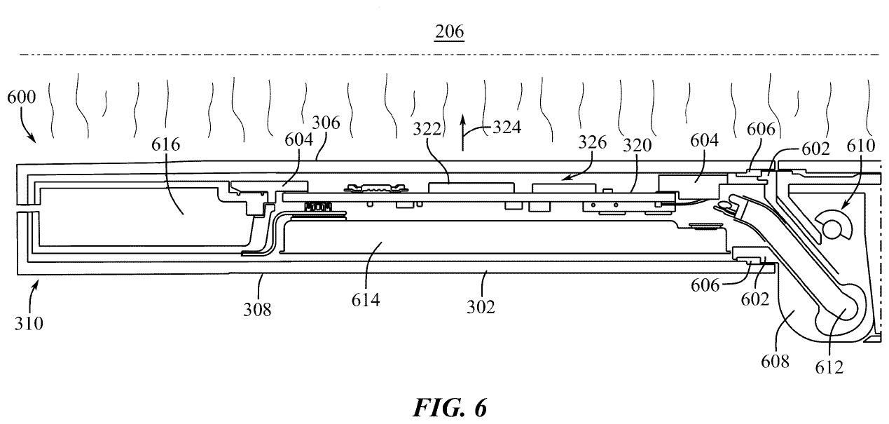

The chassis 318 can include a variety of different materials. In some examples, the chassis 318 includes a metal material. For example, the chassis 318 includes one or more base metals, such as titanium, stainless steel, tungsten, cobalt, aluminum, copper, lead, nickel, tin, zinc, gold, silver, etc. Additionally or alternatively, in certain examples, the chassis 318 includes materials other than metal. For example, the chassis 318 includes a polymer material, a carbon fiber material, a diamond material, a graphite material, silicon carbide material, etc. Combinations of the foregoing are also herein contemplated. For instance, a portion of the chassis 318 connecting to the hinge can include a metal material, and another portion of the chassis 318 can include a polymer material (e.g., as shown in FIG. 6).

The terms “PCB” or “printed circuit board” refer to a logic assembly that includes electronic components. The PCB 320 includes electrical connections and circuitry for mounting various components, including the SoC 322. The PCB 320 can also relay power to mounted electrical components from a power source (e.g., a battery, not shown in FIG. 3). In certain examples, the PCB 320 is a main logic board. The PCB 320 can be a rigid board (e.g., composed of glass-epoxy compounds). In some examples, the PCB 320 is a multi-layer PCB (e.g., a laminated sandwich structure of conductive and insulating layers). In some examples, the PCB 320 is flexible (e.g., with flexible circuitry made with polyimide). In certain examples, the PCB 320 includes stiffeners added via lamination or pressure sensitive adhesive.

The terms “SoC,” “system on chip,” or “heat source” refer to an electronic chip that generates thermal energy during operation. In some examples, the SoC 322 can include a microchip to generate (e.g., drive) visualizations presented at the display 102 (shown in FIGS. 1-2). It will be appreciated that the thermal energy or heat generated by the SoC 322 can become greater over a duration of use. Similarly, the thermal energy or heat generated by the SoC 322 can become greater when executing more data-intensive operations (e.g., for more complex or high fidelity visualizations).

As shown in FIG. 3, heat from the SoC 322 generally flows in a direction 324 towards the ambient environment 206 and away from the head 101 of a user. As discussed above, this heat flow has various advantages. To direct heat flow in the direction 324, the arm 300 can implement a variety of different approaches. In certain examples, the arm 300 implements at least one of natural conduction or non-force convection to create a thermal path for dissipating heat. In some examples, the arm 300 implements both natural conduction and non-force convection to create a thermal path for dissipating heat.

As used herein, the term “thermal path” refers to heat flow. A thermal path may be illustrated as linear or direct. However, a thermal path is not limited to such a flow path. Indeed, thermal paths can be linear or curved (e.g., non-linear), as a function of thermal properties for a given medium (whether solid, liquid, or gaseous). Further, thermal paths are not limited to two-dimensional space. It will be appreciated that thermal paths of the present disclosure include three-dimensional thermal paths through a given volume.

The term “natural conduction” refers to the heat transfer via conductively connected components. The term “non-force convection” refers to free or natural convection, where air motion is caused by natural buoyancy forces that result from the density variations due to variations of thermal temperature in the air. Non-forced convection differs from forced convection, where a fluid (e.g., air) is forced to flow by an internal source such as fans, by stirring, or pumps to create an artificially induced convection current.

To illustrate, a thermal path 328 is directed from the SoC 322, through an air gap 326 (e.g., via non-force convection), through the first surface 306, and towards the ambient environment 206. The distance between the first surface 306 and the SoC 322 defining the air gap 326 can be sized and shaped to provide a desired thermal ergonomic. For example, the air gap 326 can be reduced to create less thermal resistance between the SoC 322 and the first surface 306. Additionally, the air gap 326 can be increased to ensure the SoC 322 is mechanically decoupled from the enclosure 302 (e.g., such that the SoC 322 does not bear external loads applied to the arm 300). It will therefore be appreciated that the air gap 326 is not limited to a constant distance between the first surface 306 and the SoC 322. Indeed, the air gap 326 can be smaller in some areas and larger in other areas of the arm 300.

In some examples, the air gap 326 includes about a 0.2 millimeter (mm) gap to about a 10 mm gap. In certain examples, the air gap 326 includes about a 0.2 mm gap to about a 1 mm gap. In particular examples, the air gap 326 includes about a 0.4 mm gap to about a 0.5 mm gap.

Other thermal paths are also herein contemplated. For example, a thermal path 330 can be directed from the SoC 322, through the PCB 320, through the chassis 318, through the arm hinge 312, and towards the ambient environment 206. Although the thermal path 330 does not utilize the air gap 326, the thermal path 330 corresponds to a conductive path between components in direct contact. In particular, the thermal path 330 utilizes the thermal conductivity of the PCB 320, the chassis 318, and the arm hinge 312 to transfer heat towards the ambient environment 206. Accordingly, in one or more examples, the thermal path 330 (as a conductive path) transfers heat from the SoC 322, through the PCB 320, and through the arm hinge 312. The thermal conductivity properties of these components can be tuned or optimized to provide a desired thermal ergonomic.

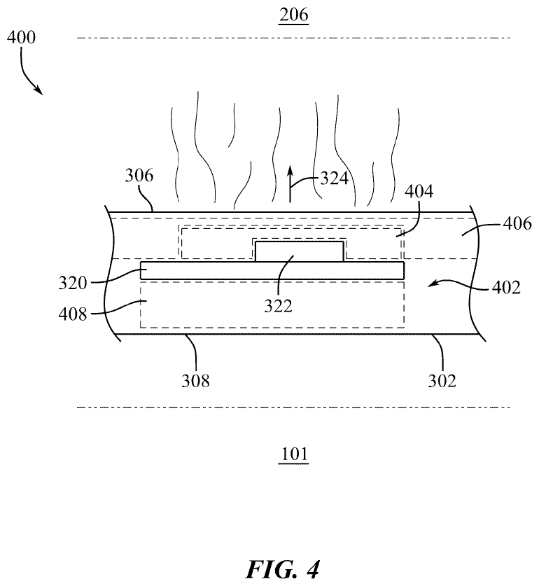

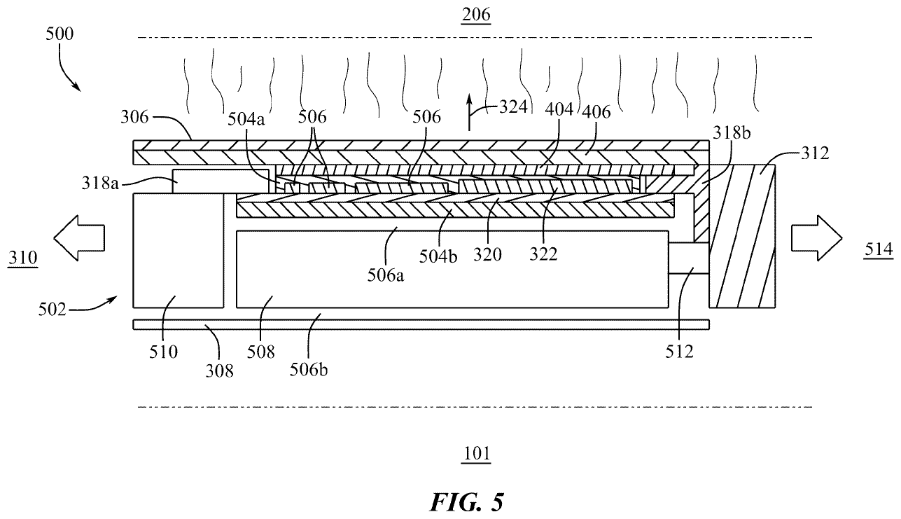

Furthermore, it will be appreciated that heat transfer utilizing the chassis 318 and the arm hinge 312 is not limited to natural conduction. For instance, another thermal path can be directed from the SoC 322, through the air gap 326 (via non-force convection), through the chassis 318, through the arm hinge 312, and towards the ambient environment 206. Still further, additional thermal paths are discussed below in relation to FIGS. 4-5. Accordingly, the arm 300 can utilize myriad different thermal paths as may be desired.

In certain examples, the arm 300 implements a single thermal path. In other examples, the arm 300 implements a combination of multiple thermal paths. The combination of the thermal paths can be designed to dissipate certain ratios of thermal energy. For example, one thermal path can be designed to distribute a larger amount of thermal energy than another thermal path. To illustrate but one example, the thermal path 328 can distribute 80% of a thermal load to the ambient environment 206, and the thermal path 330 can distribute 10% of the thermal load to the ambient environment 206 (while 10% may not be distributed by either thermal path). These ratios for the thermal paths 328, 330 can be reversed (i.e., vice-versa), modified, or tuned to achieve a desired thermal ergonomic. Indeed, surface areas, thermal conductivities, etc. can be modified to provide a particular ratio of thermal energy distribution among the thermal paths. In other examples, each thermal path is designed to distribute an equivalent amount of thermal energy to the ambient environment 206.

The arm subassembly 304 can be arranged in various different ways within the arm 300 to provide these or other thermal paths. For example, in some examples, the SoC 322 is positioned closer to the first surface 306 than the second surface 308. In certain implementations, the SoC 322 is positioned as far away from the second surface 308 as possible (or as close to the first surface 306 as possible without coupling). Some example distances between the SoC 322 and the first surface 306 are discussed above in relation to the air gap 326.

As an additional example, the SoC 322 can be oriented towards the first surface 306. In other words, the SoC 322 can be mounted to the PCB 320 such that the SoC 322 is positioned between the first surface 306 and the PCB 320. In this example, the PCB 320 can be positioned between the SoC 322 and the second surface 308.

The positions and configurations of the arm subassembly 304 can also help to mitigate undesired thermal paths. For example, by positioning the SoC 322 closer to the first surface 306 than the second surface 308, the arm 300 can transfer (or distribute) a greater thermal load to the ambient environment 206 as opposed to the head 101 of a user. Likewise, by orienting the SoC 322 towards the first surface 306 (as opposed to the second surface 308), the arm 300 can transfer (or distribute) a greater thermal load to the ambient environment 206 instead of the head 101.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3. Further details of an example arm configuration and its head dissipation design are provided below with reference to FIG. 4.

FIG. 4 illustrates a cross-sectional top view of an example arm 400 of a head-mountable display. The arm 400 can be the same as or similar to the arms 104, 106 discussed above in relation to FIGS. 1-2.

As shown, the arm 400 includes the enclosure 302 defined by the first surface 306 and the second surface 308 discussed above in relation to FIG. 3. In addition, the arm 400 includes an arm subassembly 402 which includes the PCB 320 and the SoC 322 also discussed above in relation to FIG. 3. Further, albeit not shown in FIG. 4, the arm 400 spans between an arm tip and arm hinge as similarly described above in relation to the arm tip 310 and the arm hinge 312 of FIG. 3.

Different from FIG. 3, however, the arm subassembly 402 includes (or interfaces) one or more optional components, such a thermal interfacing material 404, a thermal spreader 406, or an element 408. Each is discussed in turn.

As used herein, the term “thermal interfacing material” refers to a material inserted between components or surfaces to enhance a thermal coupling therebetween. Examples of the thermal interfacing material 404 include a thermal epoxy, thermal paste, thermal adhesive, thermal gap filler, thermally conductive pad, thermal tape, phase-change materials, or thermally conductive coatings (e.g., metallic coatings, diamond coatings, etc.). In one or more examples, the thermal interfacing material 404 can conform to the shape of the arm 400. Still further, the thermal interfacing material 404 can adjust, move, mold, or conform along an installation path as the arm subassembly 402 is inserted into the enclosure 302 (e.g., via the assembly access 314 shown in FIG. 3).

As shown in FIG. 4, the thermal interfacing material 404 can be positioned over the SoC 322 and the PCB 320. For example, the SoC 322 is sandwiched between the thermal interfacing material 404 and the PCB 320. In some examples, the thermal interfacing material 404 encapsulates a surface area of the SoC 322 not mounted to the PCB 320 (e.g., all non-mounted surfaces of the SoC 322). In certain examples, the thermal interfacing material 404 abuts (i.e., is in direct contact with) at least one surface of the SoC 322. Additionally or alternatively, the thermal interfacing material 404 abuts at least one surface of the PCB 320. In other examples, an air gap or intervening material(s) are positioned between the thermal interfacing material 404 and the SoC 322 or the PCB 320.

The thermal interfacing material 404 can include a variety of different thicknesses. As with other components or designs, the thickness of the thermal interfacing material 404 need not be a constant value. Indeed, spatial and thermal tradeoffs can factor into certain portions of the thermal interfacing material 404 having a greater thickness or a lesser thickness in the arm subassembly 402. In some examples, the thermal interfacing material 404 includes a thickness of about 0.2 mm to about 1 mm. In certain examples, the thermal interfacing material 404 includes a thickness less than about 0.5 mm. For example, in particular examples, the thermal interfacing material 404 includes a thickness of about 0.3 mm to about 0.5 mm.

In some examples, the arm subassembly 402 can interface with the thermal spreader 406. As used herein, the term “thermal spreader” refers to a material that transfers or distributes heat from a hotter source to a colder source. In some examples, the thermal spreader 406 is a thermally conductive element that disperses or spreads out the thermal energy from the arm subassembly 402 across a surface area of the thermal spreader 406. In this manner, the thermal spreader 406 can more efficiently distribute a thermal load across the first surface 306. For example, in one or more examples, the thermal spreader 406 lines an interior portion of the first surface 306 such that the thermal spreader 406 and the first surface 306 are in direct contact.

It will be appreciated that the thermal spreader 406 can be lined along the interior portion of the first surface 306 at a specific time in the assembly process. For example, in certain examples, the thermal spreader 406 can be applied to the interior portion of the first surface 306 prior to inserting the arm subassembly 402 into the enclosure 302 (e.g., via the assembly access 314 shown in FIG. 3). In certain implementations, lining the first surface 306 with the thermal spreader 406 before insertion of the arm subassembly 402 can lend to a better application of the thermal spreader 406 (e.g., a more even spread, less missed areas, etc.). Alternatively, the thermal spreader 406 is applied to the interior portion of the first surface 306 after arm subassembly 402 is inserted into the enclosure 302.

One or more different components of the arm subassembly 402 can interface with the thermal spreader 406. In some examples, the thermal interfacing material 404 interfaces with the thermal spreader 406. Additionally or alternatively, at least one of the SoC 322 or the PCB 320 interfaces with the thermal spreader 406. In these or other examples, the interface with the thermal spreader 406 can be direct, intimate contact. Alternatively, the interface with the thermal spreader 406 can be one of proximity, where the thermal spreader 406 and the interfacing element are separated by an air gap or an intervening element (e.g., an epoxy molding compound).

The thermal spreader 406 can include a variety of different materials with high thermal conductivity. Examples of the thermal spreader 406 include graphite, copper, aluminum, diamond, carbon fiber (e.g., pitched carbon fiber), etc. In the example of pitched carbon fiber, it will be appreciated that the fibers can be oriented in one or more predetermined directions. Likewise, the fibers can include one or multiple layers of oriented fibers. The layers of fibers can have the same or different orientations of fibers.

In some examples, heat transfer occurs faster in the direction that the fibers are oriented. Accordingly, in some examples, the fibers of the thermal spreader 406 can be oriented parallel to the first surface 306 to more evenly distribute a thermal load across the thermal spreader 406. In at least some cases, this parallel orientation of the fibers helps to avoid localized hot spots on the first surface 306 of the enclosure 302.

The thermal spreader 406 can also include a variety of different thicknesses. In some examples, the thermal spreader 406 ranges in thickness from about 10 micron to about 500 micron. In particular examples, the thermal spreader 406 can range in thickness from about 50 micron to about 300 micron. In certain examples, the thermal spreader 406 can include a thickness of about 100 micron. The thickness of the thermal spreader 406 is not limited to constant thickness values.

The optional element 408 can include one or more components or design configurations. In some examples, the element 408 includes an air gap, a heat sink, or an insulation material. Additionally or alternatively, the element 408 includes a battery, speaker, microphone, etc. In particular examples, the element 408 includes a combination of the foregoing.

Utilizing one or more of the foregoing components, the arm 400 can implement at least one thermal path to transfer thermal energy in the direction 324 towards the ambient environment 206 and away from the head 101 of a user. To illustrate, an arrangement of the foregoing components of the arm 400 create an example thermal path or heat flow. In particular, heat is drawn from the SoC 322 and the PCB 320, to the thermal interfacing material 404, to the thermal spreader 406, to the first surface 306, and towards the ambient environment 206.

In another example thermal path that omits the thermal spreader 406, heat is drawn from the SoC 322, to the thermal interfacing material 404, to the first surface 306, and towards the ambient environment 206. In this example thermal path, at least two of the SoC 322, the thermal interfacing material 404, or the first surface 306 are in direct contact to employ natural conduction heat transfer. Additionally or alternatively, at least one air gap exists between the SoC 322, the thermal interfacing material 404, or the first surface 306 (thereby employing non-force convection heat transfer).

In yet another example thermal path that omits the thermal interfacing material 404, heat is drawn from the SoC 322 to the thermal spreader 406, to the first surface 306, and towards the ambient environment 206. In this example thermal path, at least two of the SoC 322, the thermal spreader 406, or the first surface 306 are in direct contact for natural heat conduction. Alternatively, at least one air gap exists between the SoC 322, the thermal spreader 406, or the first surface 306 for non-force heat convection.

Other thermal paths are also herein contemplated. For example, heat is drawn from the PCB 320 to the element 408 (which can include a heat sink). Although not aligned with the direction 324, this thermal path can nonetheless mitigate thermal energy dissipated through the second surface 308.

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4. An alternative view of an example arm is detailed below with reference to FIG. 5.

FIG. 5 illustrates a cross-sectional top view of an example arm 500 of a head-mountable display. The arm 500 can be the same as or similar to the arms 104, 106 discussed above in relation to FIGS. 1-4.

As shown, the arm 500 includes an arm subassembly 502 disposed within the enclosure 302. In particular, the arm subassembly 502 abuts the thermal spreader 406 lining the first surface 306 of the enclosure 302, as discussed above in relation to FIG. 4. The arm 500 spans between the arm tip 310 to be positioned behind a user's ear and the arm hinge 312 to be positioned at or proximate to a user's temple 514.

FIG. 5 further shows additional components in the arm subassembly 502 not previously shown. For example, in addition to the thermal interfacing material 404, the arm subassembly 502 includes an epoxy molding compound in the epoxy molding compound layers 504a, 504b. As used herein, the term “epoxy molding compound” refers to an encapsulant material to encapsulate electronic components. Example materials of the epoxy molding compound include epoxy resin, hardener or curing agents, silica, catalysts, fillers, pigments, additives, etc. In some examples, the epoxy molding compound includes a low permittivity over a wide temperature range. In some examples, the epoxy molding compound has a low ionic conductivity over a wide frequency range and at elevated temperatures. In certain examples, the epoxy molding compound has a stable dielectric constant (e.g., up to 1.8 GHz).

As indicated in FIG. 5, the epoxy molding compound layer 504a can encapsulate the SoC 322 and other electrical components 506 mounted to the PCB 320. The epoxy molding compound layer 504b can cover a bottom surface of the PCB 320.

Air gaps 506a, 506b are also defined within the arm subassembly 502. For example, a spatial distance between the epoxy molding compound layer 504b and an element 508 define the air gap 506a. Likewise, a spatial distance between the element 508 and the second surface 308 of the enclosure 302 defines the air gap 506b. It will be appreciated that the air gaps 506a, 506b provide insulative qualities (e.g., to help reduce a thermal path across the second surface 308 of the enclosure 302 towards the head 101 of a user.

In certain examples, the size and shape of the air gaps 506a, 506b are dependent on the size and shape of the element 508. For example, in the case of the element 508 being a battery, the air gaps 506a, 506b can be sized to accommodate swelling of the battery during a charge cycle. In some examples, the air gaps 506a, 506b are about 2% to about 40% of the nominal thickness of the battery. In other examples, the air gaps 506a, 506b are about 5% to about 20% of the nominal thickness of the battery. In particular examples, the air gaps 506a, 506b are about 10% of the nominal thickness of the battery.

The arm subassembly 502 further includes the element 508. The element 508 can include a variety of different components. For example, the element 508 includes a heat sink or a vapor chamber. Additionally or alternatively, the element 508 can include a battery, speaker, microphone, etc. In particular examples, the element 508 can include a combination of the foregoing. In the case of a heat sink, the element 508 can help reduce a thermal path across the second surface 308 of the enclosure 302 towards the head 101 of a user. In the case of the element 508 being a battery, the air gap 506a can help protect the battery against thermal degradation. Likewise, one or more thermal paths among thermally coupled components (illustrated via a cross-hatched pattern) can draw heat away from the battery in the direction 324 to help prolong battery longevity.

In addition, the arm subassembly 502 can include an element 510. The element 510 can similarly include a number of different components like element 508. For example, the element 510 includes a heat sink. Additionally or alternatively, the element 510 can include a battery, speaker, microphone, etc. In particular examples, the element 510 can include a combination of the foregoing.

Further shown, the arm subassembly 502 can include an insulation material 512. As used herein, the term “insulation material” refers to a material that can provide thermal resistance. In at least some examples, the insulation material 512 helps mitigate heat convection to the second surface 308 of the enclosure 302. Additionally, in some examples, the insulation material provides structural support to the element 508 without (or with insubstantial) thermal conductivity from a chassis portion 318b and the arm hinge 312.

The foregoing elements just discussed can provide myriad different thermal paths, particularly among the thermally coupled components (illustrated via a cross-hatched pattern). In so doing, the arm 500 can draw heat away from the SoC 322 and in the direction 324 towards the ambient environment 206 (as opposed to the head 101 of a user). Similarly, thermal paths among the thermally coupled components can spread heat from the SoC 322 across a greater surface area of the first surface 306 for enhanced thermal dissipation towards the ambient environment 206.

In some examples, a chassis portion 318a is not thermally coupled to other components. For example, the chassis portion 318a can be composed of a non-thermally conductive material (e.g., a polymer material), while the chassis portion 318b can be composed of a thermally conductive material (e.g., metal). In this manner, the chassis portion 318a can provide structural support to temperature sensitive components, such as the element 510. Further, in certain examples, a form factor of the enclosure 302 can decrease towards the arm tip 310. Also, the arm tip 310 can house certain temperature sensitive components. Accordingly, in some examples, components thermally coupled to the SoC 322 can be limited to the thermal spreader 406 and the first surface 306 at portions extending towards the arm tip 310 of the arm 500.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5. A more detailed view of an example arm configuration having a directed thermal path is discussed below with reference to FIG. 6.

FIG. 6 illustrates a cross-sectional top view of an example arm 600 of a head-mountable display. The arm 600 can be the same as or similar to the arms 104, 106 discussed above in relation to FIGS. 1-5.

The arm 600 includes a particular exemplary arrangement of components within the scope of the present disclosure for dissipating heat in the direction 324 towards the ambient environment 206. As shown, the arm 600 includes a metal chassis portion 602 and a plastic chassis portion 604. The metal chassis portion 602 is affixed to the interior portion of the first surface 306 of the enclosure 302 at a joint 606.

The arm 600 further includes a hinge connection 608 extending from the metal chassis portion 602. The hinge connection 608 and a hinge assembly 610 work together to provide a rotatable hinge joint for the arm 600 such that the arm 600 can rotate between open and closed positions relative to the display 102 (shown in FIGS. 1-2). Disposed within the hinge connection 608 includes a cable bundle 612 routed through a cable pathway defined by the internal walls of the hinge connection 608. According to one example, some heat or thermal energy can flow through the metal chassis portion 602, through the hinge assembly 610, and to other portions of the head-mountable display for dissipation away from the user.

In addition, the arm 600 includes a battery 614. The battery 614 can be positioned between the PCB 320 and the second surface 308. Besides a power connection between the battery 614 and the PCB 320, an air gap surrounds the battery 614.

Further, the arm 600 includes a speaker 616. The speaker 616 can be positioned near the arm tip 310 of the arm 600.

It will be appreciated that one or more thermal paths discussed above can be implemented in the arm 600. In particular, heat from the SoC 322 in the arm 600 can be dissipated through an air gap above the SoC 322, through the first surface 306, and towards the ambient environment 206. Other thermal paths discussed above can also be implemented in the arm 600. For example, one or more thermal paths draw heat away from the battery 614 to improve a battery longevity.

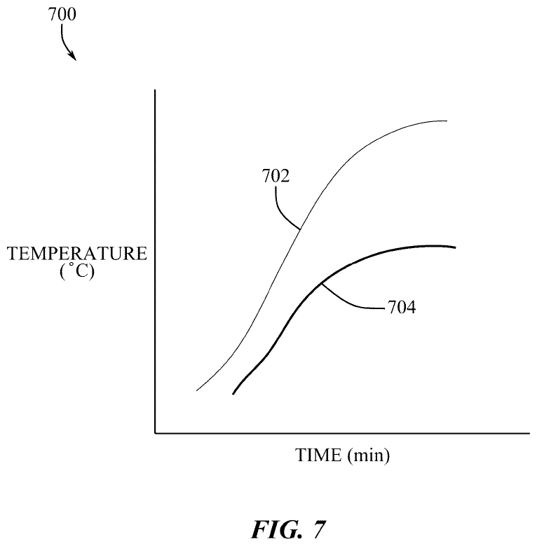

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6. Examples of the heat dissipation results accomplished with the present configuration are detailed below with reference to FIG. 7.

FIG. 7 illustrates experimental results of implementing a thermal path during a test operation in accordance with one or more examples of the present disclosure. During the experiment, experimenters operated a head-mountable display being worn and measured surface temperatures of an arm of the head-mountable display. The measured surfaces included the first surface 306 (i.e., the outer, world-facing surface) and the second surface 308 (i.e., the inner, user-facing surface), both discussed above.

In particular, FIG. 7 illustrates a graph 700 with the X-axis defined as a function of “TIME” and the Y-axis defined as a function of “TEMPERATURE.” In addition, the graph 700 includes a curve 702 indicative of a temperature for the first surface 306. Further, the graph 700 includes a curve 704 indicative of a temperature for the second surface 308.

As evident from the graph 700, temperature increases for both the first surface 306 and the second surface 308 as time progresses (i.e., as the head-mountable display performs operations). However, the curves 702, 704 indicate that more of a thermal load is dissipated through the first surface 306 compared to the second surface 308. That is, the second surface 308 adjacent to the head 101 of a user remained cooler during operation of the head-mountable display compared to the first surface 306, thereby increasing the comfort experienced by the user.

In some examples, the present systems and methods can gather and use data available from various sources that can be used to improve the delivery to users of invitational content or any other content that may be of interest to them. In some examples, the gathered data may include personal information data. The use of such personal information data should be collected, analyzed, disclosed, transferred, stored, or otherwise used in compliance with well-established privacy policies and/or privacy practices and for legitimate and reasonable uses.

While the present description includes specific nomenclature to provide a thorough understanding of the described embodiments, it will be apparent to one skilled in the art that the specific details are not required in order to practice the described embodiments. Rather, the foregoing descriptions of the specific embodiments described herein are presented for purposes of illustration and description, are not intended to be exhaustive or to limit the embodiments to the precise forms disclosed, and it will be apparent to one of ordinary skill in the art that many modifications and variations are possible in view of the above teachings.

What is claimed is:

1. An arm of a head-mountable display, comprising:
an arm hinge;
an enclosure connected to the arm hinge, the enclosure comprising a first surface, and a second surface opposing the first surface, the enclosure defining an arm tip and an internal volume spanning between the arm tip and the arm hinge;
a printed circuit board (PCB) positioned inside the internal volume;
a heat source attached to the PCB;
a thermal interfacing material and a thermal spreader material disposed between the heat source and the first surface; and
a thermal path directed from the heat source, through the thermal interfacing material, through the thermal spreader material, through the first surface, and towards an ambient environment.

2. The arm of the head-mountable display of claim 1, further comprising:
a chassis connecting the PCB to the arm hinge; and
an additional thermal path directed from the heat source, through the PCB, through the chassis, through the arm hinge, and towards the ambient environment.

3. The arm of the head-mountable display of claim 1, further comprising a heat sink positioned between the PCB and the second surface;
wherein the heat sink and the PCB define an air gap within the internal volume.

4. The arm of the head-mountable display of claim 3, further comprising an additional thermal path directed from the heat source, through the PCB, through the air gap, and to the heat sink.

5. The arm of the head-mountable display of claim 1, wherein the heat source is positioned closer to the first surface than the second surface.

6. The arm of the head-mountable display of claim 1, wherein the heat source is oriented towards the first surface.

7. The arm of the head-mountable display of claim 1, further comprising a battery positioned between the PCB and the second surface, wherein the PCB, the battery, and the second surface are spatially separated by respective air gaps.

8. A head-mountable device, comprising:
a display;
an arm housing connected to the display, the arm housing comprising a heat dissipation surface oriented towards an ambient environment; and
an arm subassembly disposed in the arm housing, the arm subassembly comprising:
a chassis;
a printed circuit board (PCB) affixed to the chassis; and
a system on chip (SoC) mounted onto the PCB and oriented towards the heat dissipation surface;
an arm hinge connected to the arm subassembly; and
a conductive path from the SoC, through the PCB, and through the arm hinge.

9. The head-mountable device of claim 8, wherein the arm housing comprises:
a uni-body enclosure connected to the arm hinge, the uni-body enclosure defining an arm tip and an internal volume between the arm tip and the arm hinge.

10. The head-mountable device of claim 9, wherein the arm housing defines an assembly access into the internal volume, the assembly access being positioned proximate to the arm hinge.

11. The head-mountable device of claim 8, wherein the heat dissipation surface inside the arm housing comprises a thermal lining that abuts the arm subassembly.

12. The head-mountable device of claim 11, wherein the thermal lining draws heat away from the arm subassembly and towards the heat dissipation surface.

13. The head-mountable device of claim 8, wherein the arm subassembly further comprises thermal insulation disposed between the PCB and a surface of the arm housing opposite the heat dissipation surface.

14. The head-mountable device of claim 8, wherein the arm subassembly further comprises a thermal interfacing material and an epoxy molding compound.

15. A thermal flow apparatus of an augmented reality glasses arm, comprising:
a printed circuit board (PCB);
a heat source attached to the PCB;
a heat dissipation surface oriented towards an ambient environment, the heat dissipation surface extending from a proximal end to a distal end of the augmented reality glasses arm; and
a thermal spreader material disposed adjacent to the heat source, the thermal spreader material lining an inner portion of the heat dissipation surface between the proximal end and the distal end.

16. The thermal flow apparatus of claim 15, further comprising:
a thermal interfacing material positioned between the thermal spreader material and the heat source.

17. The thermal flow apparatus of claim 16, wherein the at least one of the thermal interfacing material or the thermal spreader material directs thermal energy away from the heat source and towards an ambient environment via at least one of natural conduction or non-force convection.

18. The thermal flow apparatus of claim 15,
wherein the thermal spreader material comprises at least one of a pitch-based carbon fiber material, a graphite material, or a copper material.

19. The thermal flow apparatus of claim 18, further comprising an insulator disposed adjacent to the heat source opposite the thermal spreader material.

20. The thermal flow apparatus of claim 15,
wherein the thermal spreader material spreads a thermal load from the heat source across the heat dissipation surface.
